(19) United States
(12) Patent Application Publication
(10) Pub. No.: US 2007/0124327 A1
(43) Pub. Date: May 31, 2007

(54) METHOD OF CREATING A FILE FOR A PATTERNING MASK

(76) Inventor: Jung Soo Park, Incheon (KR)

Correspondence Address: SHERR & NOURSE, PLLC, 620 HERNDON PARKWAY, SUITE 200, HERNDON, VA, 20170, US

(21) Appl. No.: 11/564,117

(22) Filed: Nov. 28, 2006

(30) Foreign Application Priority Data
Nov. 30, 2005 (KR) 10-2005-0115439

(51) Int. Cl. G06F 7/00

(52) U.S. Cl. 707/102

(57) ABSTRACT

Disclosed is a method which may convert files containing information about a mask to create a file for patterning a mask. A plurality of files may be processed at the same time regardless of the number of files containing mask information. Final fracture files may be created from a plurality of mask information files at the same time, which may reduce processing time.

The present application claims priority under 35 U.S.C. 119 and 35 U.S.C. 365 to Korean Patent Application No. 10-2005-0115439 (filed on Nov. 30, 2005), which is hereby incorporated by reference in its entirety.

### BACKGROUND

When an interconnection is formed over a semiconductor substrate during manufacturing, a photolithography process may be employed for interconnections with a narrow width. A mask may be used in a photolithography process. A mask may be patterned by operating and/or controlling an apparatus that patterns the mask. Operating and/or controlling an apparatus may use a file that contains information for patterning a mask.

A file (e.g. mask information file) may have information about a mask. A file may not be directly executed by a mask patterning apparatus. In order to execute a mask information file in a mask patterning apparatus, the mask information file may need to be converted (e.g. compiled). Because mask information files may need to be individually processed, it may take a relatively long time to process (e.g. convert) the mask information files. After a request is made to pattern a mask, mask information files may need to be corrected again. A mask information file may need to be corrected multiple times. A mask information file maybe relatively large (e.g. in the order of Giga bytes). Due to a relatively large size of a mask information file, valuable time may be lost during reprocessing of the mask information file.

### SUMMARY OF THE INVENTION

Embodiments relate to a method of converting files containing information about a mask to a file for patterning a mask. In accordance with embodiments, a plurality of files may be processed at the same time, regardless of the number of files containing mask information. In embodiments, a mask may be patterned at a relatively high speed. In embodiments, the number of errors in a process of patterning a mask may be minimized. Embodiments relate to parameter processing of mask information files which may convert multiple mask information files into final fracture files at the same time.

According to embodiments, a method of creating a file for patterning a mask comprises at least one of the following steps: performing mask data processing (MDP) on at least two mask information files at the same time; creating at least two intermediate files; fracturing two intermediate files at the same time; and/or creating at least two final fracture files. Performing a MDP to create at least two intermediate files may be performed using an MDP rule file, an MDP shell script file, and/or an MDP execution file. Creating at least two final fracture files may be performed using a fracturing rule file, a fracturing shell script file, and/or a fracturing execution file. MDP may include a shrinkage step, an extraction step for each layer, and/or an insertion step for a dummy pattern.

A shrinkage step, an extraction step for each layer, and/or an insertion step for a dummy pattern may be performed substantially at the same time. Each Intermediate file may be associated with one mask information file. A MDP rule file may have a name of each mask information file input as a parameter. A fracturing rule file may have a name of each intermediate file input as a parameter. In embodiments, there may be a step of checking final fracture files. A step of checking final fracture files may check at least two final fracture files at the same time.

### BRIEF DESCRIPTION OF DRAWINGS

Example FIG. 1 illustrates substrate information contained in a mask information file, in accordance with embodiments.

Example FIG. 2 is an enlarged view of section A of FIG. 1, in accordance with embodiments.

Example FIGS. 3 through 6 illustrate information of a file after shrinkage, extraction of each layer, and/or insertion of a dummy pattern, in accordance with embodiments.

Example FIGS. 4 and 5 are enlarged views of section B of FIG. 3, in accordance with embodiments.

Example FIG. 6 is an enlarged view of section C of FIG. 3, in accordance with embodiments.

Example FIG. 7 illustrates a part of a file used in mask data processing (MDP), in accordance with embodiments.

Example FIG. 8 illustrates an MDP rule file, in accordance with embodiments.

Example FIG. 9 illustrates an MDP shell script file, in accordance with embodiments.

Example FIG. 10 illustrates an MDP execution file, in accordance with embodiments.

Example FIG. 11 illustrates a fracturing rule file, in accordance with embodiments.

Example FIG. 12 illustrates a fracturing shell script file, in accordance with embodiments.

Example FIG. 13 illustrates a fracturing execution file, in accordance with embodiments.

Example FIG. 14 illustrates an automatic fracturing file, in accordance with embodiments.

FIG. 15 illustrates mask information in a final fracture file, in accordance with embodiments.

FIG. 16 is an enlarged view of section L of FIG. 15, in accordance with embodiments.

FIG. 17 illustrates an example of checking a final fracture file using an EDA tool, in accordance with embodiments.

### DETAILED DESCRIPTION

FIG. 1 illustrates substrate information contained in a mask information file, in accordance with embodiments. FIG. 2 illustrates an enlarged view of section A of FIG. 1, in accordance with embodiments. FIGS. 3 through 6 illustrate information in a file after 90% shrinkage, extraction of each layer, and insertion of a dummy pattern, in accordance with embodiments. FIGS. 4 and 5 illustrate enlarged views of section B of FIG. 3, in accordance with embodiments. FIG. 6 is an enlarged view of section C of FIG. 3, in accordance with embodiments. FIG. 7 illustrates part of a file used in mask data processing (MDP), in accordance with embodiments.

A mask information file, in which information illustrated in FIGS. 1 and/or 2 may be contained, may create a file for patterning a mask by shrinking the information (e.g. shrinking the information to at 90% of the original size). One of ordinary skill in the art will appreciate that information may be shrunk to many different proportion (e.g. 85%). Extraction of each layer and insertion of a dummy pattern may be performed together with shrinkage of information.

Shrinking information, extracting each layer, and/or inserting a dummy pattern may performed by a MDP process at substantially the same time. A MDP process may be performed in various different ways. In embodiments, MDP may be performed using an electronic design automation (EDA) tool. An example of an EDA tool is calibre.

A MDP rule file, a MDP shell script file, and/or a MDP execution file may be required to process a plurality of mask information files, which may be processed at the same time. A MDP rule file may store rules applied in a MDP step. A MDP rule file may perform parameter processing to process a plurality of mask information files. A MDP shell script file may receive parameters of mask information files. A MDP shell script file may execute each mask information file using an execution file to perform a MDP. A MDP execution file may function to allow a MDP to be performed on mask information files at the same time as using a MDP rule file and/or a MDP shell script file.

FIGS. 8, 9 and 10 illustrate images of three files, in accordance with embodiments. FIG. 8 illustrates a MDP rule file, in accordance with embodiments. FIG. 9 illustrates an MDP shell script file, in accordance with embodiments. FIG. 10 illustrates an MDP execution file, in accordance with embodiments.

A plurality of mask information files may be processed by a MDP at the same time by operation of a MDP execution file. An intermediate file may be created for each of the plurality of mask information files.

An example of parameter processing is illustrated in section D of FIG. 8, in accordance with embodiments. The section D of FIG. 8 is a portion of the name of an input file (i.e. a portion indicated by “GDS_FILE”). A plurality of file names may each be input using a portion of the name of an input file as a parameter. A file name may be adapted to be input using a parameter, so that a file having a different name may be input. In embodiments, as illustrated in section D, the name of a top structure (e.g. a portion indicated by “TOP_NAME”) may be processed using a parameter.

Section E of FIG. 8 may indicate a shrinking process rather than a magnifying process. Section F may input the name of an output intermediate file. Section G may input the name of an output process summary file. Section H may define an external boundary of an applied section. A boundary can be defined using a parameter.

A fracturing process may create final fracture files using created intermediate file. A fracturing process of creating a final fracture file may be similar to a DMP process. A DMP process may create one intermediate file permask information file. A fracturing process may create multiple (e.g. ten) final fracture files per mask information file. A fracturing process may use a relatively large amount of data. One of ordinary skill in the art would appreciate the that any number of final fracture files may be generated from a mask information file.

A fracturing process of creating final fracture files may require a fracturing rule file, a fracturing shell script file, a fracturing execution file, and/or an automatic fracturing file in order to process a plurality of intermediate files at the same time. A fracturing rule file may contain rules for converting a plurality of intermediate files into final fracture files. A fracturing rule file may require parameter processing in order to process a plurality of intermediate files at the same time.

A fracturing shell script file may be an execution file that receives at least one parameter about each intermediate file to fracture each of the intermediate files. A fracturing execution file may create multiple final fracture files per intermediate file using the fracturing rule file and the fracturing shell script file. An automatic fracturing file may be a program that allows every final fracture file to be automatically created through a fracturing execution file. An automatic fracturing file may allow for all final fracture file to be created at the same time. An automatic fracturing file may allow for each intermediate file created multiple final fracture files at the same time.

FIGS. 11 through 14 illustrate files, according to embodiments. FIG. 11 illustrates an example fracturing rule file, in accordance with embodiments. FIG. 12 is illustrates an example fracturing shell script file, in accordance with embodiments. FIG. 13 illustrates an example fracturing execution file, in accordance with embodiments. FIG. 14 illustrates an example automatic fracturing file, in accordance with embodiments. Similar to MDP, a fracturing process may execute multiple final fracture files at the same time. Executing multiple final fracture files maybe accomplished by three files (e.g. a fracturing rule file, a fracturing shell script file, and a fracturing execution file).

In FIG. 11, section I illustrates an example of inputting of a name of an intermediate file to which a fracturing process may be applied. A name of an intermediate file to be input using a parameter may be input, so that a fracturing process can be performed together with another file having a different name. Section J is an example of at least one parameter that defines a range after shrinkage, in accordance with embodiments. Section K is an example of one designated name of one of the multiple final fracture files created from each intermediate file, in accordance with embodiments. The names of multiple final fracture files should be different from each other.

Final fracture files may be used as files that are executed to pattern masks in mask patterning equipment. In embodiments, it may be necessary to check whether or not created final fracture files are correctly created. Embodiments relate to a method of checking all files at a time when checking final fracture files. Names of final fracture files may be input using parameters and may be checked all together.

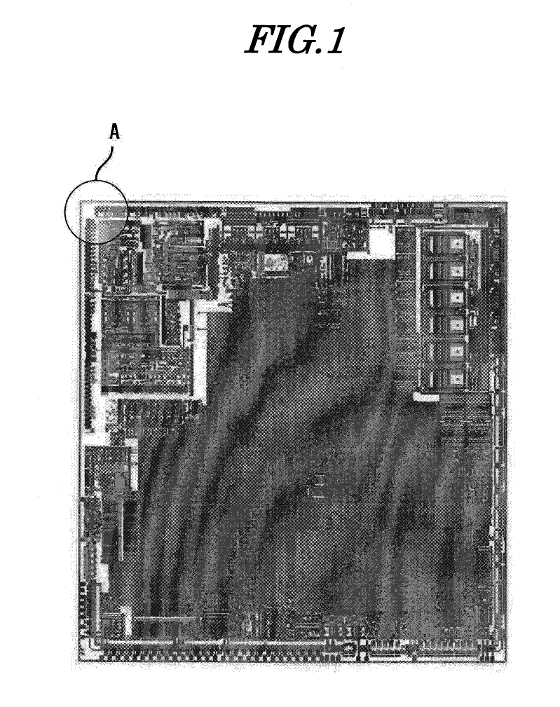

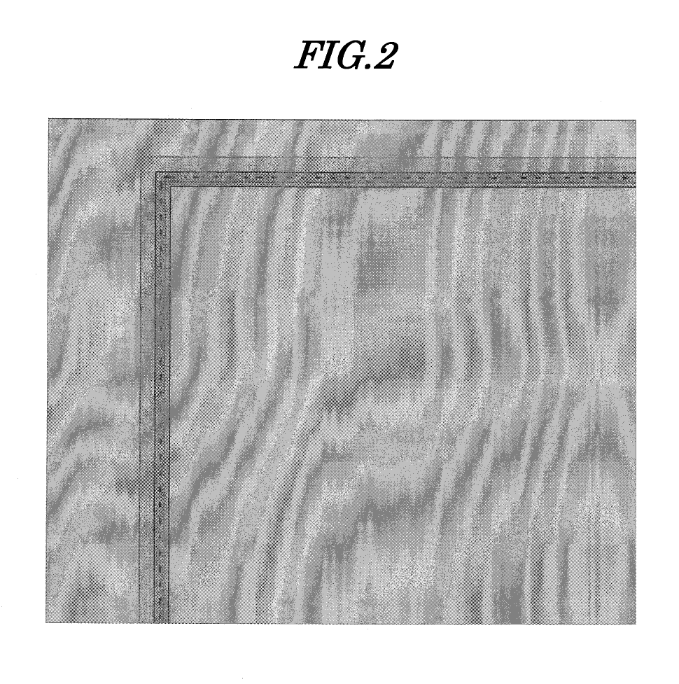

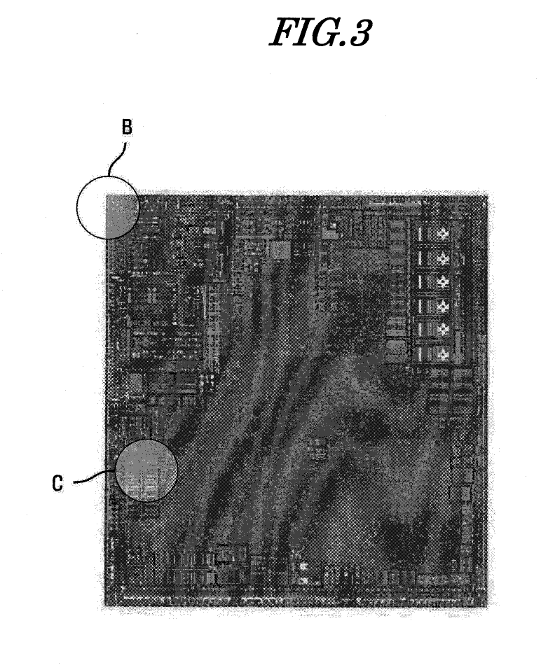

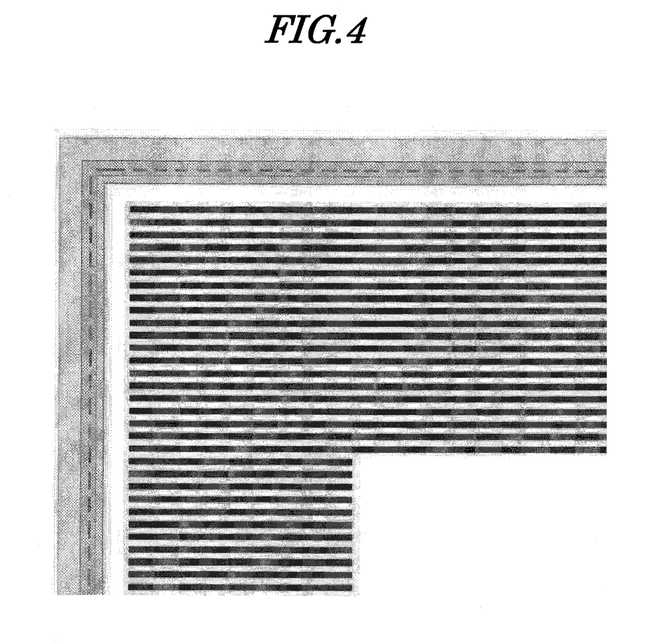

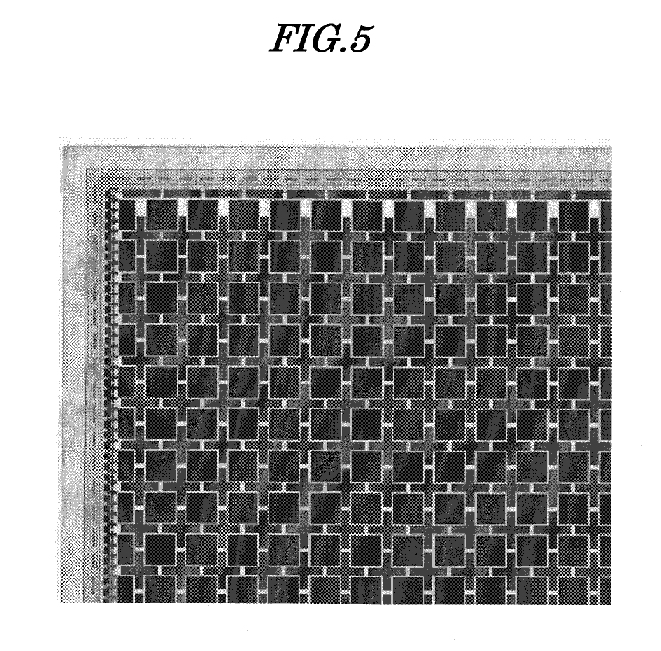

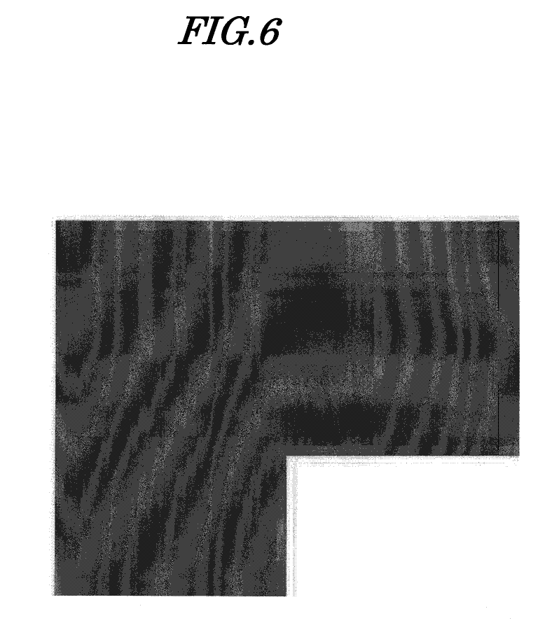

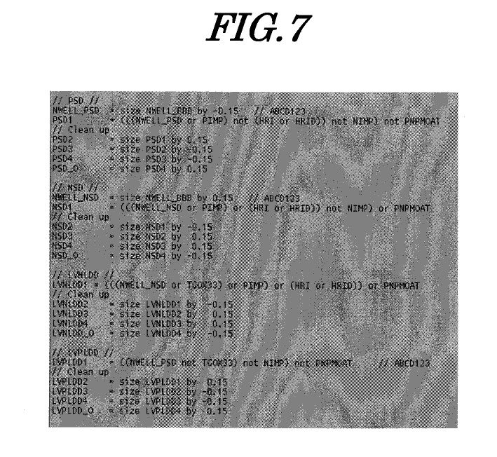

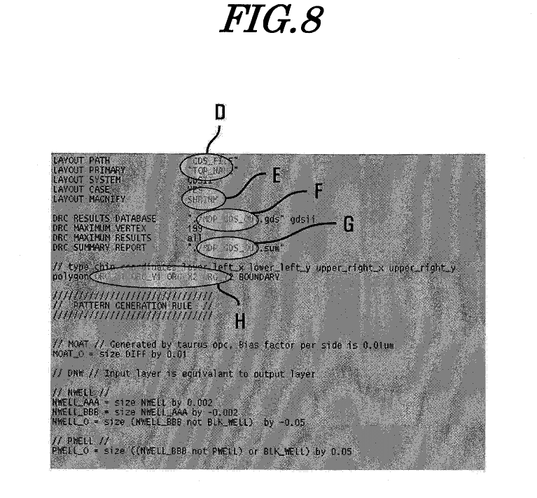

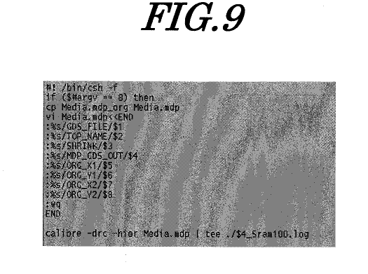

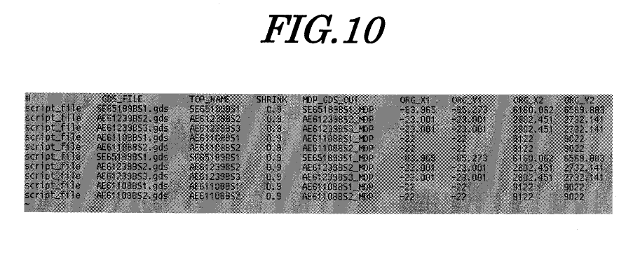

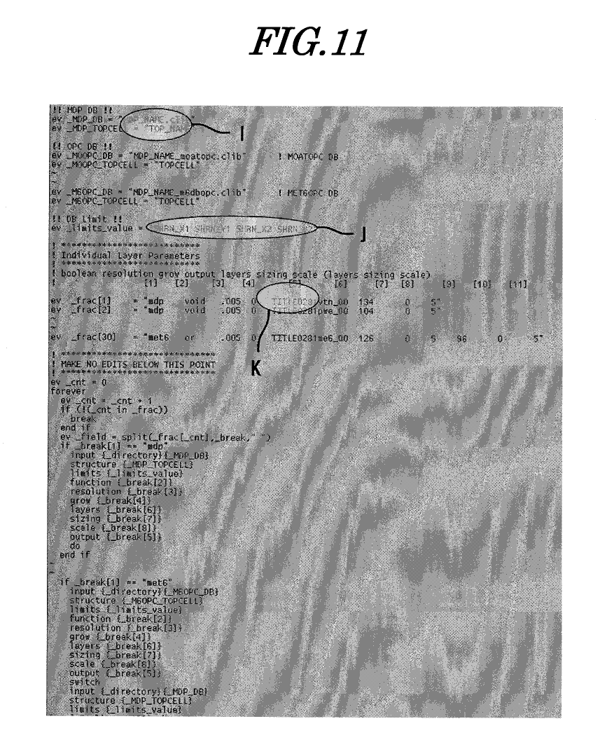

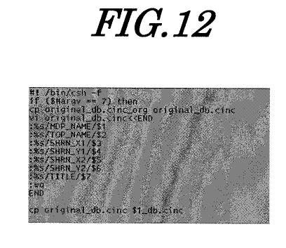

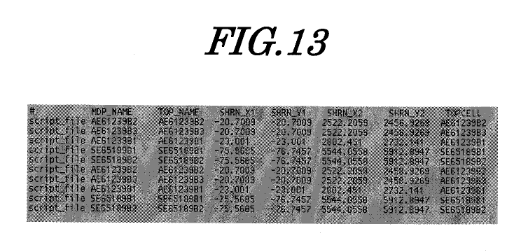

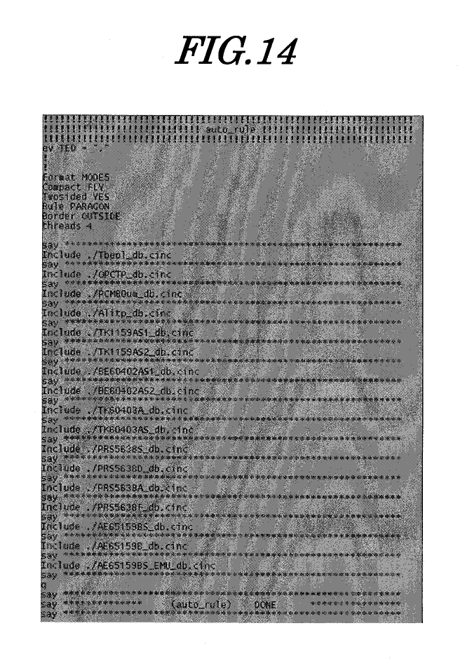

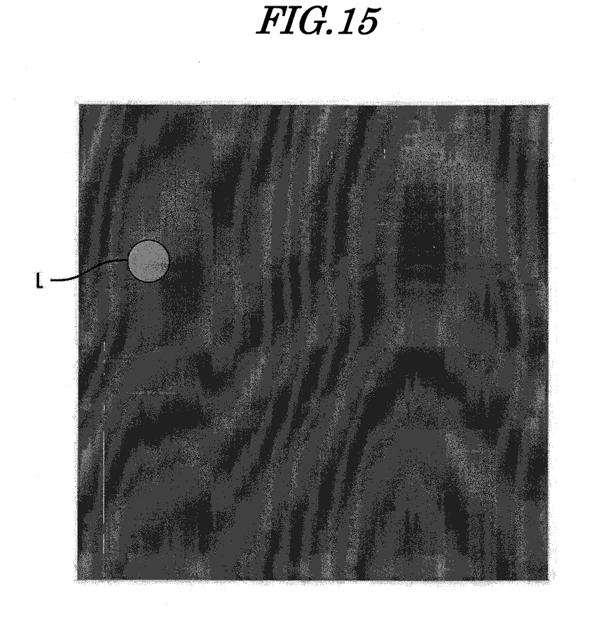

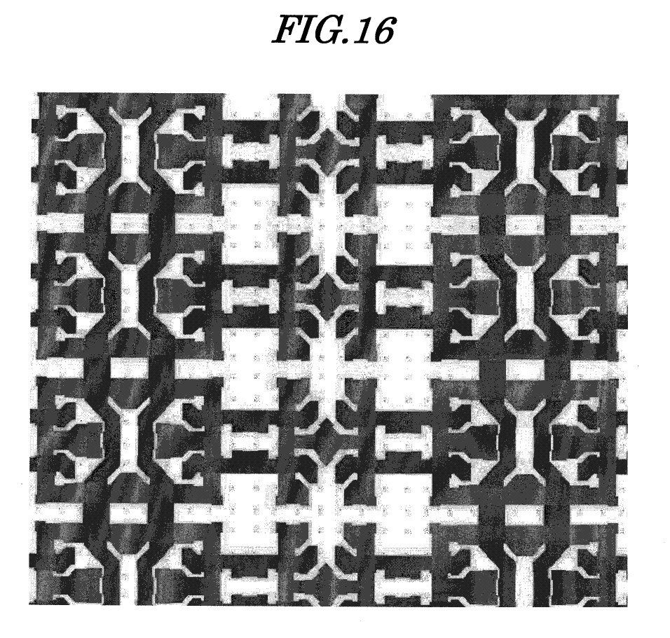

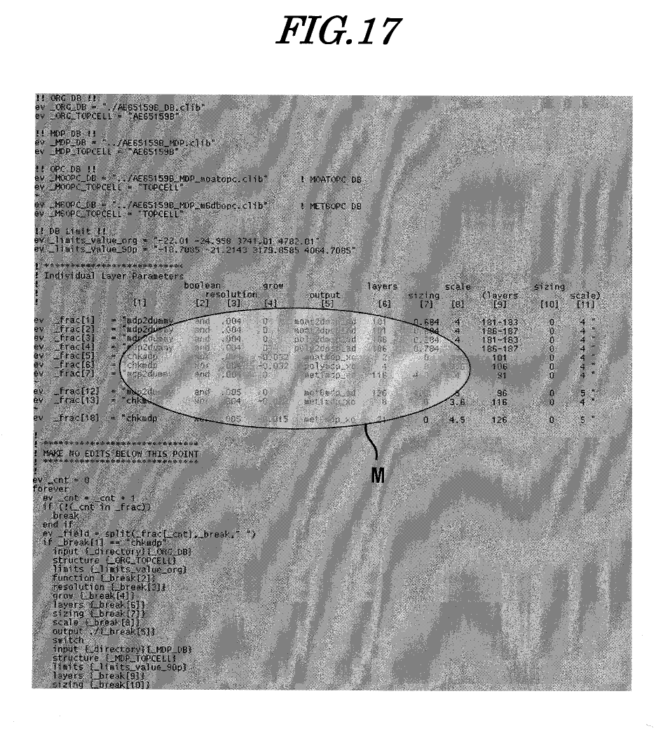

Example FIG. 15 illustrates example mask information of a final fracture file, in accordance with embodiments. Example FIG. 16 illustrates an enlarged view of section L of FIG. 15, in accordance with embodiments. FIG. 17 illustrates an example of checking a final fracture file using an EDA tool, in accordance with embodiments.

The following are examples of items of a final fracture file that may be checked:

Original Moat vs. Dummy Moat and Dummy Poly Space;

Original POLY vs. Dummy Moat and Dummy Poly Space;

Original Moat vs. Dummy Moat and Dummy Poly Overlap;

Original Poly vs. Dummy Moat and Dummy Poly Overlap;

Original Moat, Poly and Metal vs. MDPed Moat, Poly and Metal Check; and/or

MDPed Moat, Poly and Metal vs. OPCed Moat, Poly and Metal Check.

In checking items, it may be important to check whether or not an inserted dummy pattern is correctly inserted, in accordance with embodiments. In checking items, it may be important to check whether or not optical proximity correction (OPC) is correctly performed.

Section M of FIG. 17 illustrates an example portion showing checking items and their checked results. If each result value is 0 (null), there is no problem, in accordance with embodiments.

Examples of items capable of being converted into a parameter (according to embodiments) include name of an OPC input file, name of an MDP input/output file, name of an MDP top structure, information on an original chip size, name of an output mask data file, and/or other similar information.

In embodiments, a process of creating final fracture files may be performed according to each mask information file. A name of a file may be set as a parameter. Final fracture files may be created all together from a plurality of mask information files having different names using a set file name, in accordance with embodiments. Embodiments may reduce process time. A process of checking final fracture files may set a name of each file as a parameter. A process may check a plurality of files all together, which may reduce process time, in accordance with embodiments.

It will be apparent to those skilled in the art that various modifications and variations can be made to embodiments. Thus, it is intended that embodiments cover modifications and variations thereof within the scope of the appended claims.

What is claimed:

1. A method comprising:
performing mask data processing on at least two mask information files; and
creating at least two intermediate files from the at least two mask information files.

2. The method of claim 1, wherein said performing mask data processing is performed at substantially the same time.

3. The method of claim 1, comprising fracturing the at least two intermediate files to create at least two final fracture files.

4. The method of claim 3, comprising checking the final fracture files.

5. The method of claim 4, wherein said checking the final fracture files checks the at least two final fracture files at substantially the same time.

6. The method of claim 3, wherein said fracturing the at least two intermediate files is performed at substantially the same time.

7. The method of claim 3, wherein said fracturing is performed using at least one of:
a fracturing rule file;
a fracturing shell script file; and
a fracturing execution file.

8. The method of claim 7, wherein the fracturing rule file has a name of each of said at least two intermediate files input as a parameter.

9. The method of claim 1, wherein said performing mask data processing is performed using at least one of:
a mask data processing rule file;
a mask data processing shell script file; and
a mask data processing execution file.

10. The method of claim 9, wherein the mask data processing rule file has a name of each of said at least two mask information files input as a parameter.

11. The method of claim 1, wherein the method creates a file for patterning a mask.

12. The method of claim 1, wherein the mask data processing comprises shrinking at least one of said at least two mask information files.

13. The method of claim 12, wherein said shrinking comprises shrinking to 90% of original size.

14. The method of claim 1, wherein the mask data processing comprises extracting layer of at least one of said at least two mask information files.

15. The method of claim 1, wherein the mask data processing comprises inserting a dummy pattern.

16. The method of claim 1, wherein:
the mask data processing comprises shrinking at least one of said at least two mask information files;
the mask data processing comprises extracting layer of at least one of said at least two mask information files;
the mask data processing comprises inserting a dummy pattern; and
said shrinking, said extracting, and said inserting are performed at substantially the same time.

17. The method of claim 1, wherein each of said at least two intermediate files are created to correspond to one of said at least two mask information files.
